(19) United States
(12) Patent Application Publication
(10) Pub. No.: US 2007/0222635 A1
(43) Pub. Date: Sep. 27, 2007

(54) Remote Control Receiver Device

(75) Inventors: Ramon Antoine Wiro Clout, Eindhoven (NL); Richard Marcel Pierre Doornbos, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,246

(22) PCT Filed: Jun. 1, 2005
(86) PCT No.: PCT/IB05/51779

§ 371 Date: Dec. 8, 2006

(30) Foreign Application Priority Data
Jun. 9, 2004 (EP) 04102613.9

(51) Int. Cl. H02J 13/00

(52) U.S. Cl. 340/825.52

(57) ABSTRACT

The invention relates to a remote control receiver device (100) that is arranged to be in a network with one or more consumer electronic devices (CED₁; CED₂; CED_{N}). The remote control receiver device (100) can receive remote control signals (1) from a remote control (20) and can transmit derived control signals (2, 3, 4) for one or more consumer electronic devices (CED₁; CED₂; CED_{N}) in the network. Thus, it is not necessary that the individual consumer electronic devices comprises a remote control receiver. The remote control receiver device (100) preferably performs filtering and translation of the received remote control signals, so that the derived control signals transmitted to a consumer electronic device only contains the signals relevant for that consumer electronic device and so that the remote control signals have been interpreted to become useful to the consumer electronic device.

This invention relates to a remote control receiver device arranged to receive remote control signals transmitted from a remote control device. The invention moreover relates to a method of handling remote control signals at a remote control receiver device. Finally, the invention relates to a system comprising one or more networked consumer electronic devices and to a consumer electronic device.

Today, many homes have a variety of consumer electronic devices or appliances which can be controlled from a remote position by means of remote controls. Universal remote controls can be arranged to be able to control a plurality of consumer electronic devices, thereby providing more flexibility to the user, in that he/she might only need one remote control transmitter. The signals sent from a remote control are typically coded to indicate the appliance for which it is intended as well as to convey operational instructions keyed in on the remote control. The appliances are typically arranged to filter out the signals, they can receive, and interpret these signals. However, the above does not provide optimum flexibility, in that universal remote controls typically are truly universal, in that they typically can only be used with a limited range of consumer electronic devices or appliances. Thus, if a user replaces one of his/her consumer electronic devices, a remote control receiver in the new consumer electronic device may not be able to interpret the remote control signals from the existing remote control.

U.S. Pat. No. 5,815,086 describes a system comprising an universal transmitter that can be used with any appliance comprising an IR receiver. The universal transmitter is connected to a signal-carrying bus from which it receives commands, in that a receiver is provided for receiving commands from a remote control. These commands are translated by the universal transmitter to a modulated infrared signal compatible with the infrared receiver of the appliance. Thus, the appliance can be retrofitted with an existing appliance automation system. However, it is a drawback that the implementation of the system described in U.S. Pat. No. 5,815,086 necessitates the provision of an additional receiver and an additional transmitter unit, in that these devices take up space and can be rather high-priced.

It is an object of the invention to provide a remote control receiver device rendering greater flexibility in the case, where more than one consumer electronic device is to be controlled by a remote control device.

This object among others is achieved, when the remote control receiver device mentioned in the opening paragraph is characterized in that said remote control receiver device is arranged to be in a network with one or more consumer electronic devices, that the remote control receiver device comprises reception means arranged to receive said remote control signal for at least a first consumer electronic device among the one or more consumer electronic devices, and that the remote control receiver device is arranged to transmit a control signal derived from said received remote control signal to said at least first consumer electronic device via said network. Since the remote control receiver device is in a network with the consumer electronic devices, to which it is arranged to transmit remote control signals, the placement of the remote control receiver device is arbitrary. Thus, the remote control receiver device can be incorporated in a consumer electronic device, which is able to be connected to a network, or it can be a separate device. Between the remote control receiver device and the consumer electronic devices in the network is a network link instead of a remote control signal link, such as an infrared link. Thus, the consumer electronic devices in the network need not comprise any remote control receiver device, in that they receive the remote control signals via the network. It is a further advantage by the remote control receiver device according to the invention that a plurality of consumer electronic devices can receive control signals derived from the same remote control signal; thus, timed multi-media presentations on a plurality of devices can be provided simultaneously. Yet another advantage of the invention is that in the case where the remote control signals are infrared signals, only the remote control receiver device, and thus not (all) the consumer electronic device(s) need to be in line of sight of the remote control to receive control signals. In one example of an implementation of the above, the consumer electronic device(s) and the remote control receiver device could be connected wired or wireless in/to a home network, such as ethernet.

It is preferable, when the remote control receiver device is arranged to provide filtering and/or translation of said received remote control signals. A filtering of received remote control signals renders it possible in the remote control receiver device to select those signals a consumer electronic device needs. A translation of received remote control signals can render the control signals sent from the remote control receiver device to the networked consumer electronic devices semantically richer. By filtering and/or translating the received remote control signals, a consumer electronic device may receive the derived control signals that it requires and/or can get the derived control signal as semantically rich signals (e.g. receive “standby” instead of “0×0C”).

In a preferred embodiment, the remote control receiver device comprises a configuration interface for creation of filtering rules and/or translation rules related to said filtering and/or translation of said received remote control signals. Thus, a user can influence the composition of the filtering and/or translation rules used in the remote control receiver device. Preferably, the remote control receiver device further comprises storage means, on which a set of default filtering rules and/or default translation rules is/are stored. Thus, the remote control receiver device can be programmed to suit the most common user needs. For example, the remote control receiver device could be programmed to be able to transmit control signals to a television, a DVD-player and audio equipment.

In yet another preferred embodiment, a set of filtering rules and/or translation rules is/are stored on a computer server which the remote control receiver device is arranged to access. Thus, filtering rules and/or translations rules according to the use of the remote control receiver device can be downloaded, for example when a new consumer electronic device is coupled to the network, when a user wishes to change the set-up of the remote control receiver device, etc. The filtering and/or translation rules can be written down in a document (e.g. an XML document), which is stored on the computer server. The URI (Universal Resource Identifier), e.g. http://www.ietf.org./rfc/rfc2396.txt, of this document could be a parameter used to access the document.

In a further preferred embodiment the remote control receiver device is arranged to receive a requested set of filtering and/or translation rules from a consumer electronic device, so that said requested set of filtering and/or translation rules can be used as a parameter to a session between the remote control receiver device and said consumer electronic device. Hereby, each session between a consumer electronic device and the remote control receiver device can be configured separately and can have separate and possibly unique filtering and/or translation rules. It should be noted, that a session is an instantiation of the service (i.e. the relaying of remote control signals) offered by the remote control receiver device to the consumer electronic devices in the network.

Preferably, the remote control receiver device according to the invention further comprises means for time stamping the transmitted control signal. Hereby, the remote control receiver device is able to time stamp received remote control signals and thus the consumer electronic device(s) receiving the control signal derived from the received remote control signal can regain the original time for reception of the remote control signal at the remote control receiver device. This is advantageous, in that control signals, which are derived from the received remote control signals and which may be filtered and/or translated, in a networked environment may take some time to travel from the remote control receiver device to the consumer electronic device, for which it is intended. By time stamping the received remote control signals, e.g. timed multi-media presentations can be rendered simultaneously on a plurality of consumer electronic devices.

Preferably, the reception means of the remote control receiver device according to the invention is arranged to receive remote control signals in the form of Infrared (IR) signals or Radio Frequency Identification (RFID) signals. The use of IR signals is advantageous in that it is a well known technique; the use of RFID signals is advantageous in that the remote control receiver device need not be in line of sight of the remote control; actually, the remote control receiver device could be located in different room from the remote control.

The invention furthermore relates to a method of handling remote control signals at a remote control receiver device, to a system comprising one or more networked consumer electronic devices and to a consumer electronic device. The method, system and consumer electronic device comprise features corresponding to the device described above and thus representing similar advantages.

It should be noted that as used herein, the term “remote” is intended to refer to any location which is outside of the housing or cabinet of a consumer electronic device, appliance or other device. The term “consumer electronic device” as used herein is meant to cover any electronic device or appliance controllable by a remote control device. Typical examples on consumer electronic devices could be, but are not limited to: television sets, DVD players, CD player, VCRs, AM/FM tuners, audio cassette decks, laser disc players, any audio and video signal processing equipment, cable TV control boxes, computers, etc.

The invention will be explained more fully below in connection with a preferred embodiment and with reference to the drawing, in which:

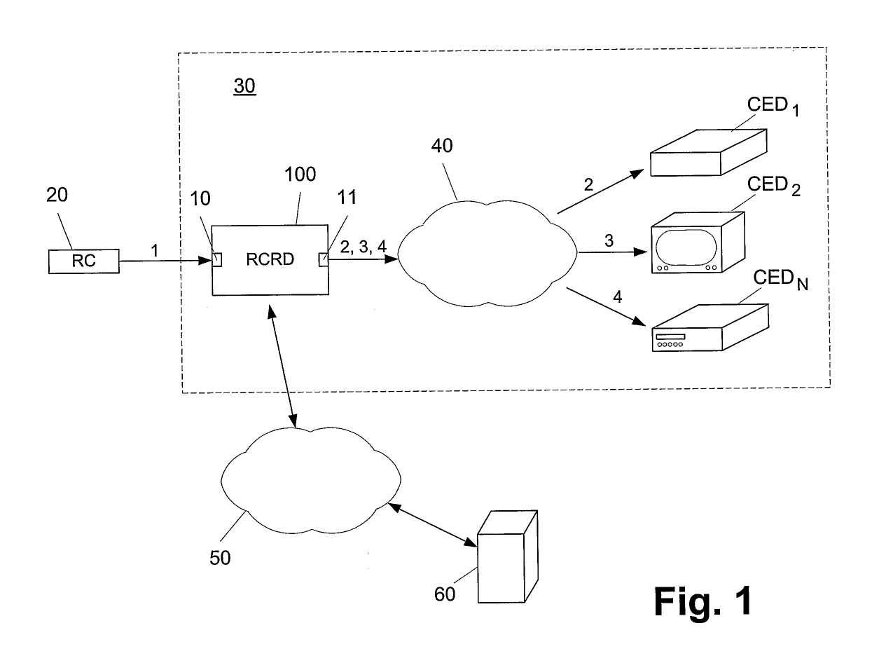

FIG. 1 shows a schematic drawing of a network comprising a remote control receiver device and consumer electronic devices according to the invention.

FIG. 1 shows a schematic drawing of a network 30 comprising a remote control receiver device (RCRD) 100 and consumer electronic devices CED₁, CED₂, CED_{N} (where N is equal to or larger than 1) according to the invention. The remote control receiver device 100 is arranged to be connected (wired or wirelessly) in the network 30 with the one or more consumer electronic devices CED₁, CED₂, CED_{N} via network means 40. Thus signals 2, 3, 4 from the remote control receiver device 100 can be transmitted to the consumer electronic devices CED₁, CED₂, CED_{N} connected to the network 30 via the network means 40. The network means 40 could be any appropriate means for establishing a wired or wireless network 30, such as a home network (e.g. Ethernet), local network, etc. In the case when the network 30 is a wireless network, any appropriate, current or future technology for providing wireless connectivity can be used, e.g. Bluetooth, IrDA, HomeRF, WLAN, WPAN, and UWB.

Shown is a remote control (RC) 20, which is arranged to transmit remote control signals 1 conveying operation instructions for controlling one or more of the consumer electronic devices CED₁, CED₂, CED_{N}. The remote control 20 contains means (not shown), such as keys, buttons or a pressure sensitive display, by which a user can generate instructions to be transmitted in a remote control signal 1. Such a remote control signal could e.g. be an infrared signal, a Bluetooth or an RFID signal; however, other current or future remote control signals are conceivable, too. The remote control signal 1 can be received by reception means 10 in or at the remote control receiver device 100.

The remote control receiver device 100 is arranged to provide filtering and/or translation of received remote control signals 1 originating from the remote control 20, thereby deriving a control signal 2, 3, 4 from said remote control signal 1.

By filtering of the received remote control signals 1, the remote control receiver device 100 can filter out the signals intended for a selected one of the consumer electronic devices CED₁, CED₂, CED_{N}, so that only those control signals, which are intended for a specific consumer electronic device, are sent to that specific consumer electronic device. Of course, the remote control signal 1 sent from the remote control 20 could be intended for more than one of the consumer electronic devices, e.g. in multi-media presentations; in this case, the filtering taking place in the remote control receiver device 100 of course takes this into account so that the relevant filtered control signals are sent to the relevant consumer electronic devices. In the figure, the control signal 2 is intended for and transmitted to the consumer electronic device CED₁, the control signal 3 is intended for and transmitted to the consumer electronic device CED₂ and the control signal 4 is intended for and sent to the consumer electronic device CED_{N}. The filtering could be performed on the basis of the remote control code set. For example, the remote control receiver device 100 could be configured to receive RC5 or RC6 signals only. Alternatively, the remote control receiver device 100 could be configured to receive remote control signals for a specific device (e.g. a DVD player) only.

By translation of received remote control signals 1, the remote control receiver device 100 can render the control signals 2, 3, 4 transmitted from the remote control receiver device 100 to the networked consumer electronic devices CED₁, CED₂, CED_{N} semantically richer. Thus, a consumer electronic device CED₁, CED₂, CED_{N}, may receive control signals 2, 3, 4 as semantically rich signals (e.g. receive “standby” instead of “0×0C”).

The remote control receiver device 100 can comprise a configuration interface (not shown) for creation of filtering rules and/or translation rules related to the filtering and/or translation of received remote control signals 1. Thus, a user can influence the filtering and/or translation rules implemented in the remote control receiver device. Typically, the remote control receiver device 100 comprises one or more sets of default filtering rules and/or one or more sets of default translation rules. These default rules can be selected and/or changed by means of the configuration interface of the remote control receiver device.

Also shown in the Figure is a computer server 60, e.g. a web server, which can be accessed by the remote control receiver device 100 via means 50 for accessing the computer server 60, e.g. via the Internet. The means 50 could be any means for providing access to a remote computer server, such as e.g. a modem, ADSL, HDLS, RADSL, VDSL or ISDN connection.

On the server 60 a document (e.g. XML documents) could be stored, containing filtering and/or translation rules. The URI (Universal Resource Identifier) of the document containing the filtering and/or translation rules could be used by the remote control receiver device 100 to access the filtering and/or translations rules.

The network 30 could advantageously use the Universal Plug and Play (UPnp) standard using Internet and Web protocols to enable consumer electronic devices to be plugged into the network and automatically know about the existence of other devices in the network.

However, as mentioned above, the remote control receiver device 10 also could be incorporated in one of the consumer electronic devices CED₁, CED₂, CED_{N} arranged to be connected in the network 30.

It should be noted that in the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. Moreover, the mere fact that certain measures are recited in mutually different dependent claims does not indicate that a combination of these measures cannot be used to advantage.

1. A remote control receiver device (100) arranged to receive remote control signals (1) transmitted from a remote control device (20), characterized in that
said remote control receiver device (100) is arranged to be in a network (30) with one or more consumer electronic devices (CED₁; CED₂; CED_{N}),
said remote control receiver device (100) comprises reception means (10) arranged to receive said remote control signal (1) for at least a first consumer electronic device (CED₁; CED₂; CED_{N}) among the one or more consumer electronic devices (CED₁; CED₂; CED_{N}), and
said remote control receiver device (100) comprises transmitter means (11) arranged to transmit a control signal (2; 3; 4) derived from said received remote control signal (1) to said at least first consumer electronic device (CED₁; CED₂; CED_{N}) via said network (30).

2. A remote control receiver device (100) according to claim 1, characterized in that the remote control receiver device (100) is arranged to provide filtering and/or translation of said received remote control signals (1).

3. A remote control receiver device (100) according to claim 2, characterized in further comprising a configuration interface for creation of filtering rules and/or translation rules related to said filtering and/or translation of said received remote control signals (1).

4. A remote control receiver device (100) according to claim 1, characterized in further comprising storage means, on which a set of default filtering rules and/or default translation rules is/are stored.

5. A remote control receiver device (100) according to claim 1, characterized in that a set of filtering rules and/or translation rules is/are stored on a computer server (60) which the remote control receiver device (100) is arranged to access.

6. A remote control receiver device (100) according to claim 3, characterized in that it is arranged to receive a requested set of filtering and/or translation rules from a consumer electronic device (CED₁; CED₂; CED_{N}), so that said requested set of filtering and/or translation rules can be used as a parameter to a session between the remote control receiver device (100) and said consumer electronic device (CED₁; CED₂; CED_{N}).

7. A remote control receiver device (100) according to claim 1, characterized in further comprising means for time stamping the transmitted control signal (2; 3; 4).

8. A remote control receiver device (100) according to claim 1, characterized in that the reception means (10) of the remote control receiver device (100) is arranged to receive remote control signals (1) in the form of Infrared (IR) signals or Radio Frequency Identification (RFID) signals.

9. A method of handling remote control signals (1) at a remote control receiver device (100), characterized in comprising the following steps:
arranging said remote control receiver device (100) in a network (30) with one or more consumer electronic devices (CED₁; CED₂; CED_{N}),
receiving a remote control signal (1) for at least a first consumer electronic device (CED₁; CED₂; CED_{N}) among the one or more consumer electronic devices (CED₁; CED₂; CED_{N}) by means of reception means (10) at said remote control receiver device (100), and
by means of transmitter means (11) in said remote control receiver device (100) transmitting a control signal (2; 3; 4) derived from said received remote control signal (1) to said at least first consumer electronic device (CED₁; CED₂; CED_{N}) via said network (30).

10. A method according to claim 9, characterized in further comprising the step of filtering and/or translation of said received remote control signals (1).

11. A method according to claim 10, characterized in further comprising the step of creating filtering rules and/or translation rules related to said filtering and/or translation of said received remote control signals (1).

12. A method according to claim 9, characterized in further comprising the step of accessing a set of default filtering rules and/or default translation rules, which is/are on stored storage means of the remote control receiver device (100).

13. A method according to claims 9, characterized in further comprising the step of accessing a set of filtering rules and/or translation rules stored on a computer server (60) which the remote control receiver device (100) is arranged to access.

14. A method according to claim 11, characterized in further comprising the step of, at a consumer electronic device (CED₁; CED₂; CED_{N}), transmitting a requested set of filtering and/or translation rules to the remote control receiver device (100), so that said requested set of filtering and/or translation rules can be used as a parameter to a session between the remote control receiver device (100) and said consumer electronic device (CED₁; CED₂; CED_{N}).

15. A method according to claim 9, characterized in further comprising the step of time stamping the transmitted control signal (2; 3; 4).

16. A method according to claim 9, characterized in that the remote control signal (1) received by reception means (10) of the remote control receiver device (100) is in the form of Infrared (IR) signals or Radio Frequency Identification (RFID) signals.

17. A system comprising one or more networked consumer electronic devices (CED₁; CED₂; CED_{N}) characterized in further comprising a remote control receiver device according to claim 1.

18. A consumer electronic device (CED₁; CED₂; CED_{N}) arranged to be in a network (30) with a remote control receiver device (100) according to claim 1 and comprising means for receiving a control signal (2; 3; 4) transmitted from said remote control receiver device (100) via said network (30).
